(19) United States
(12) Patent Application Publication
(10) Pub. No.: US 2008/0234044 A1
(43) Pub. Date: Sep. 25, 2008

(54) GAMING MACHINE HAVING TOUCH PANEL SWITCH

(75) Inventor: Eiji AIDA, Zama city (JP)

Correspondence Address: GLOBAL IP COUNSELORS, LLP, 1233 20TH STREET, NW, SUITE 700, WASHINGTON, DC, 20036-2680, US

(73) Assignee: KONAMI GAMING INCORPORATED, Las Vegas, NV (US)

(21) Appl. No.: 11/689,494

(22) Filed: Mar. 21, 2007

(51) Int. Cl. A63F 13/06

(52) U.S. Cl. 463/37

(57) ABSTRACT

A touch panel switch assembly according to the present invention is installed in a gaming machine, and comprises a base, a moving unit, an elastic member, a display unit, a position sensor, and a mechanical switch unit. The moving unit is supported by the base fixed on the gaming machine, and can move in the direction perpendicular to the surface thereof. The elastic member can exert a restoring force between the base and the moving unit when a player has pushed the moving unit. The display unit is mounted on the base or the moving unit, and visible through the moving unit. The position sensor can detect a position on the moving unit where the player has touched. The mechanical switch unit is mounted between the base and the moving unit, and can be turned on and off depending on the position of the moving unit.

### BACKGROUND OF THE INVENTION

1. Field of the Invention

The present invention relates to a gaming machine, and in particular a gaming machine comprising a touch panel serving as an input device.

2. Background Information

Gaming machines such as slot machines, poker machines, fruit machines, and the like generally attract enormous popularity from players in casinos. These types of gaming machines display an arrangement of symbols on the front thereof, and change the types of symbols in the arrangement at random. A player guesses on which line of the arrangement (i.e. payline) a specific combination of symbols (i.e. winning combination) will appear, and places a bet on the payline before the symbols are changed in the arrangement. If a winning combination appears on the payline on which the player has placed a bet, the player will win an amount of a payout that depends on the amount of the bet and the type of the winning combination.

These types of gaming machines are generally remodeled at frequent intervals in order to continuously attract many players. Remodeling of gaming machines often requires replacement of the mechanisms thereof, such as mechanical reels and push buttons serving as input devices, in their entirety. Accordingly, recent gaming machines tend to reduce mechanical portions in order to facilitate frequent remodeling and maintenance thereof. For example, mechanical reels are replaced with virtual reels (i.e., video reels) displayed in graphic form on a screen of an electric display device. Push buttons separately assigned to types of bets and paylines, a spin button or lever, and the like, are replaced with virtual buttons displayed on a touch panel, which are assigned to various functions of the gaming machine by software. Remodeling of such a gaming machine generally requires only data updates, such as image data for use in the display on the screen and the touch panel, and data about the relationship between the virtual buttons displayed on the touch panel and the functions of the gaming machine.

The touch panel serving as an input device can also expand the variety of visual effects for a game, and increase the number of modes per game conducted by the gaming machine. Images displayed on the touch panel can be freely changed with response to the changes of game status. The design in number, shape, and pattern of the virtual buttons can be flexibly changed, depending on the functions required in different game modes. Accordingly, the touch panel may enhance players' willingness to play games on the gaming machine.

However, touch panels mounted on prior art gaming machines can generally provide virtual buttons with very short or no stroke length (e.g., Japan Published Patent Applications Nos. 1997-292948 and 2000-284911). In fact, the touch panel disclosed in JP 2000-284911 cannot receive bias current required to detect the position of a finger touching the screen until the finger moves the touch panel 13 downward to change the mechanical switch 20 to its on position. The shorter stroke length may facilitate quicker selection of functions on one hand, but may increase the risk of incorrect input on the other hand. In particular, players prefer a sufficiently tactile feedback from the pushed button, e.g., when cuing video reels for the start of a “spin” (i.e., continuous vertical movement of symbols on the screen).

In view of the above, it will be apparent to those skilled in the art from this disclosure that there exists a need for an improved gaming machine with a touch panel serving as an input device, which can both facilitate quicker selection of functions, and provide a sufficiently tactile feedback to a player to reduce the risk of incorrect input. This invention addresses this need in the art as well as other needs, which will become apparent to those skilled in the art from this disclosure.

### SUMMARY OF THE INVENTION

A touch panel switch assembly according to the present invention is preferably installed in a gaming machine, and serves as an input device. The touch panel switch comprises a base, a moving unit, an elastic member, a display unit, a position sensor, and a mechanical switch unit. The base is preferably fixed on the cabinet of the gaming machine. The moving unit is supported by the base and configured to move in the direction perpendicular to the surface of the base. The elastic member is connected between the base and the moving unit, and configured to exert a restoring force therebetween when a user has displaced the moving unit in the direction perpendicular to the surface of the base. The display unit is mounted on the base or the moving unit, and configured to be visible through the surface of the moving unit. The display unit is preferably of a panel or film type, and is configured to form or be mounted on the surface of the moving unit. The position sensor is mounted on the moving unit, and configured to detect a position on the surface of the moving unit where the user has touched. The display unit and the position sensor cooperate as a touch panel. The position sensor is preferably configured to be a resistive or capacitive touch panel. This type of the position sensor is more preferably covered with the screen of the film-type display unit. Alternatively, the position sensor may be overlaid on the panel-type display unit. The mechanical switch unit is mounted between the base and the moving unit, and configured to be turned on and off depending on the position of the moving unit in the direction perpendicular to the surface of the base.

The touch panel switch assembly allows the user to enter two types of signal. One of the types is entered through the position sensor, and the other is through the mechanical switch unit. The combination of the display unit and the position sensor enables quicker and easier data input by using the relationship between data options and images displayed on the display unit, since the user only has to touch the displayed image corresponding to data options to be entered. The combination also allows flexible changes in the relationship, and thereby can expand the variety of acceptable data options and visual effects. This enhances functionality and flexibility in design of a device equipped with the touch panel switch assembly. On the other hand, the mechanical switch unit allows the user to use the moving unit in its entirety as a “push button”. In particular, the elastic member can provide a sufficiently tactile feedback from the moving unit when the moving unit is pushed and turns on the mechanical switch unit. Whether data content entered through the position sensor is accepted immediately, or on condition that the mechanical switch is turned on, the variety of acceptable data options can be further expanded. Data acceptance on condition that the mechanical switch is turned on can also reduce the risk of incorrect input for the data.

The touch panel switch assembly is especially suitable for use in a gaming machine as an input device. The gaming machine comprises a game control unit configured to execute a game program. The game control unit thereby controls images on the display unit. The game control unit further identifies the data that a player has entered into the gaming machine by using the relationship between the images displayed on the display unit and the positions detected by the position sensor, and the on and off positions of the mechanical switch unit. Here, the game control unit is preferably configured to assign available data options to specific images, and display a matrix of the specific images on the display unit. In that case, the game control unit preferably identifies the data option assigned to the specific image displayed at the position that has been detected by the position sensor. The game control unit then controls game functions depending on the identified data, and provides the player with an award depending on the game result and the identified data. The game control unit is preferably configured to perform a game function according to the identified data when detecting that the player has pushed the moving unit and thereby turned on the mechanical switch unit.

The combination of the display unit and the position sensor can expand the variety of visual effects for a game, and increase the number of modes per game conducted by the gaming machine. Images displayed on the display unit can be freely changed with response to the changes of game status. The design in number, shape, and pattern of the images can be flexibly changed, depending on the functions required in different game modes. Thus, the touch panel switch assembly can not only facilitate frequent model changes of the gaming machine, but also enhance players' willingness to play games on the gaming machine. On the other hand, the touch panel switch assembly can provide players with a sufficiently tactile feedback from the moving unit, preferably when cuing video reels for the start of a spin and confirming the amount of bet and the selected paylines. This can reduce the risk of incorrect input.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a perspective view of the external appearance of a gaming machine according to an embodiment of the present invention;

FIG. 2 is a block diagram of the configuration of the gaming machine shown in FIG. 1;

FIG. 3 is a perspective view of a touch panel switch assembly according to an embodiment of the present invention;

FIG. 4 is an exploded perspective view of the touch panel switch assembly shown in FIG. 3;

FIGS. 5A and 5B are cross sectional views of the touch panel switch assembly shown in FIG. 3;

FIG. 6 is a schematic exploded perspective view of the components enclosed in the moving unit shown in FIG. 3;

FIG. 7 is a perspective view of a touch panel switch assembly according to another embodiment of the present invention;

FIG. 8 is an exploded perspective view of the touch panel switch assembly shown in FIG. 7;

FIGS. 9A and 9B are cross sectional views of the touch panel switch assembly shown in FIG. 7; and

FIGS. 10A and 10B are schematic views of a player's finger touching and pushing the touch panel switch according to the embodiment of the present invention.

### BEST MODE FOR CARRYING OUT THE INVENTION

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

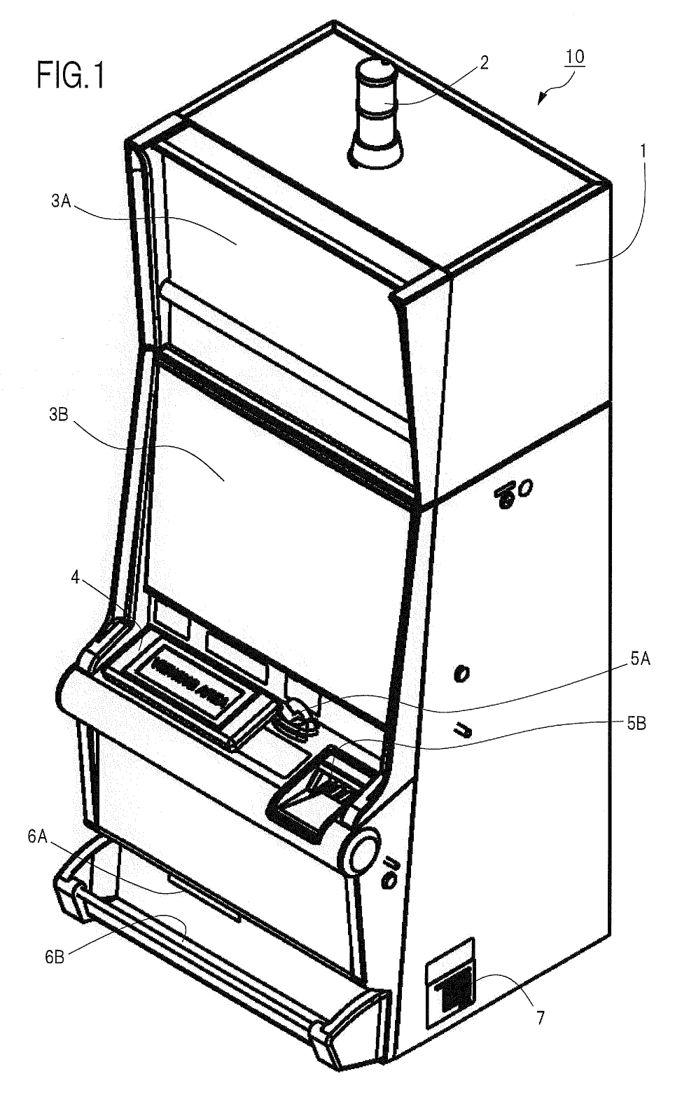

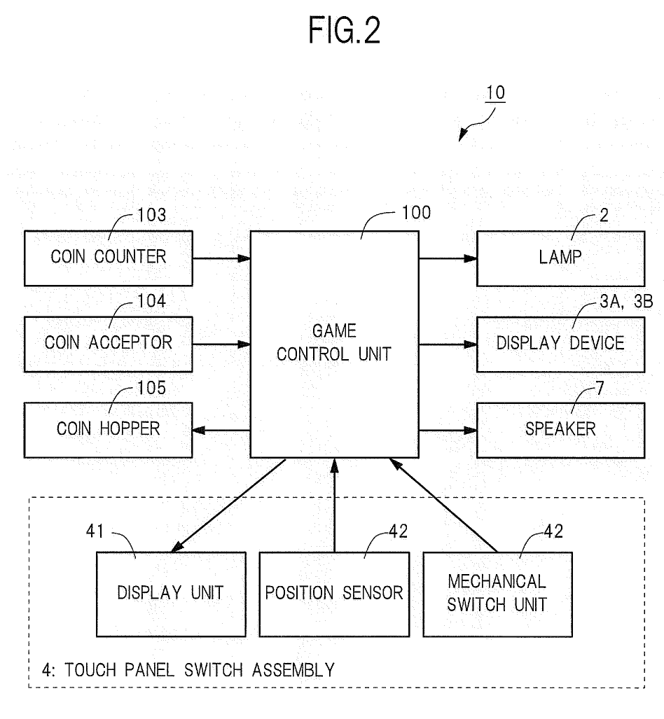

A gaming machine according to an embodiment of the present invention is preferably of a standalone type slot and installed in a casino. Alternatively, the gaming machine may be of a download or thin-client type and controlled by a server through a LAN. The gaming machine 10 is preferably a video slot machine as shown in FIGS. 1 and 2. Alternatively, the gaming machine 10 may be of a stepper-reel type. As shown in FIG. 1, the components of this slot machine 10 visible from the exterior include a cabinet 1, a lamp 2, display devices 3A, 3B, a touch panel switch assembly 4, a coin slot 5A, a bill slot 5B, a coin chute 6A, a coin tray 6B, and a speaker 7. As shown in FIG. 2, the components of this slot machine 10 mounted inside the cabinet 1 and invisible from the exterior include a game control unit 100, a coin counter 103, a coin acceptor 104, and a coin hopper 105.

The lamp 2 is used mainly as a signal for informing service personnel of a request for change or an error, or alternatively, as decoration and visual effects in games. The lamp 2 can blink and/or change brightness and color in specific patterns. The lamp 2 may be mounted on, for example, the top of the cabinet 1 as shown in FIG. 1, and in addition, the front, sides, and rear of the cabinet 1.

The display devices 3A and 3B are preferably included in a liquid crystal display, or alternatively, may be included in a cathode-ray-tube display or a plasma display. Each display device 3A and 3B receives external image data, and reproduces images which correspond to the image data. The images include, for example, images for use in decoration, such as the image of a logo of a game developer, images for use in advertisements, images for use in visual effects in games and the display of information about games, such as pay tables, illustrations of game content (i.e., a game screen), the amount of a bet, the number of credits available, and a jackpot meter. In particular, the main display device 3B displays three or more columns of various symbols arranged in a predetermined order, i.e., video reels.

The touch panel switch assembly 4 is a main input device of the gaming machine 10, which accepts various kinds of instructions from a player. The instructions in particular include a request for a game program selected by a player and an instruction from a player to change game status. The touch panel switch assembly 4 preferably displays a matrix of virtual buttons assigned to various functions of the gaming machine 10. The touch panel switch assembly 4 can detect the position at which a player touches. The touch panel switch assembly 4 can also serve in its entirety as a “push button” having a sufficiently long stroke length, and thereby provide the player with a sufficiently tactile feedback while it is pushed (details will be described below). A player selectively touches and/or pushes the virtual buttons, preferably in order to select paylines and the amount of a bet, and cue the video reels for the start of a spin. Alternatively, a keyboard image and a numeric keypad image may be displayed thereon, thereby allowing a player to freely enter characters and numerals. Note that operation buttons such as a bet button and a spin button and/or a spin lever may be mounted on the cabinet 1 in addition to the touch panel switch assembly 4 (not shown in FIG. 1).

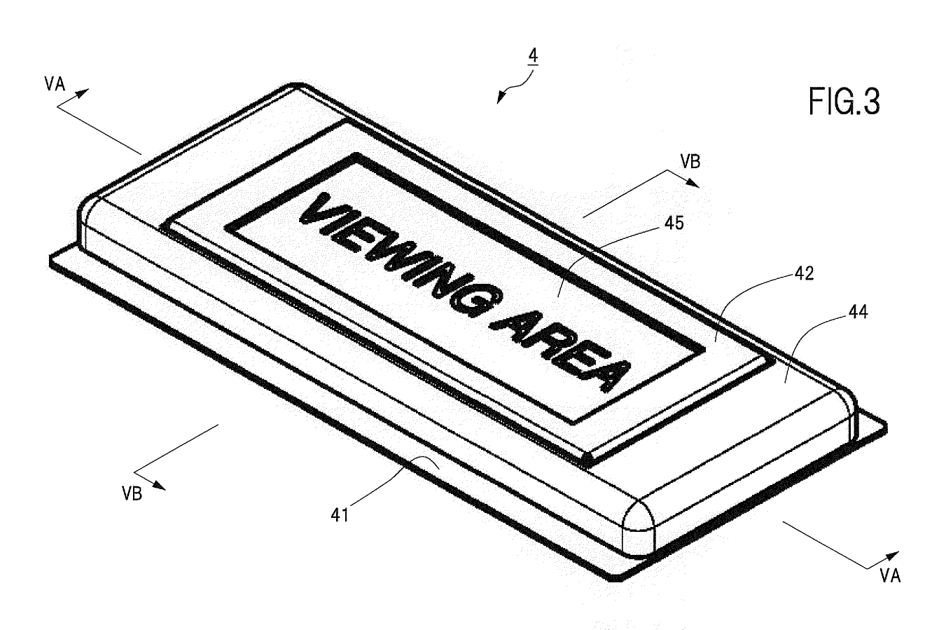

As shown in FIGS. 3, 4, 5A, and 5B, one example of the touch panel switch assembly 4 comprises a base 41, a moving unit 42, elastic members 43, a frame 44, a display unit 45, a position sensor 46, and a mechanical switch unit 47.

The base 41 is a plate preferably made of metal, or alternatively, plastic. The base 41 is preferably fixed at an easy-to-reach position on the front panel of the cabinet 1 below the main display device 3B (cf. FIG. 1). The corners of the moving unit 42 are supported by the base 41 through the elastic members 43 coupled to spacers 41A on the base 41. The moving unit 42 is thereby configured to move in the direction perpendicular to the surface of the base 41. The movable range of the moving unit 42 is adjusted by the length of the spacers 41A. This allows the touch panel switch assembly 4 to provide a sufficiently long stroke length. The elastic members 43 are preferably a coil spring, or alternatively may be a conical spring washer, a sleeve made of elastomer, or an O-ring. The elastic members 43 are positioned around each of the spacers 41A. A screw 43A passes through a washer 43B and a hole 42A opened at each corner of the moving unit 42 in that order, and then coupled to a female thread provided at the top of each spacer 41A. Thus, the elastic members 43 are connected between the base 41 and the moving unit 42, and configured to exert a restoring force therebetween when a player has pushed and displaced the moving unit 42 in the direction perpendicular to the surface of the base 41. The restoring force can provide the player a sufficiently tactile feedback from the moving unit 42. Note that the number and position of the elastic members 43 may be changed, depending on the type thereof, the shape and weight of the moving unit 42, and the like. The frame 44 shields the periphery of the base 41 and the moving unit 42. A broad opening 44A is provided at the top surface of the frame 44. A player can touch the top surface of the moving unit 42 through the opening 44A.

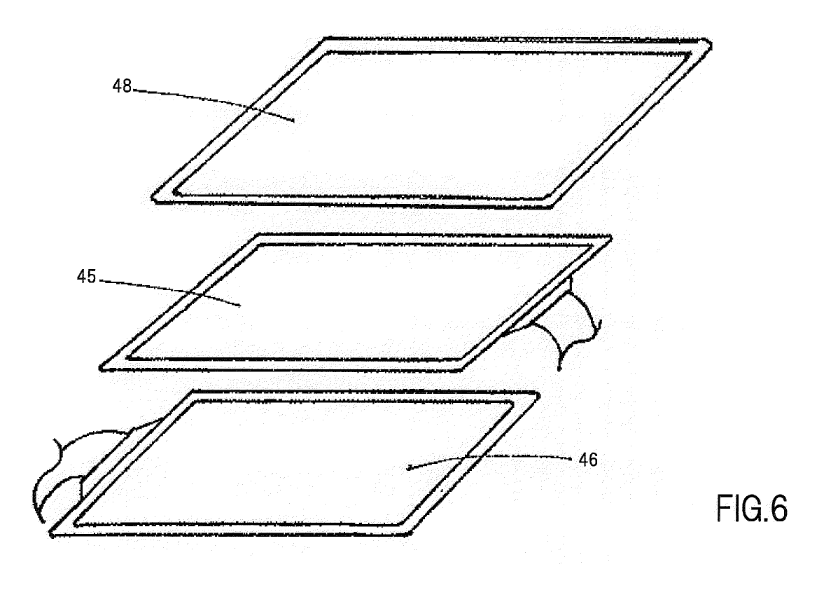

In the moving unit 42, the display unit 45 is stacked on the position sensor 46, or vice versa, as shown in FIG. 6. In particular, the screen of the display unit 45 is visible through the opening 44A of the frame 44 as shown in FIG. 3. In addition, a cover sheet 48 may be placed on the display unit 45 and the position sensor 46 for protection. The display unit 45 is preferably of a film type such as flexible LCD, organic electroluminescent display device (OLED), and electric paper. This type of the display unit 45 has a locally deformable screen, which elastically yields to the pressure from the player's finger touching the screen. Alternatively, the display unit 45 may be of a panel type such as LCD implemented on a glass substrate and a matrix of LEDs. This type of the display unit 45 is hard to deform. The position sensor 46 is configured to detect a position on the top surface of the moving unit 42, in particular the screen of the display unit 45, where a player has touched. The position sensor 46 is preferably configured to be a resistive or capacitive touch panel. This type of the position sensor 46 is more preferably covered with the screen of the film-type display unit 45. Alternatively, the position sensor 46 may be overlaid on the panel-type display unit. In this case, the position sensor 46 has to be optically transparent. Note that other types of the position sensor 46 (e.g., an infrared type, an acoustic-wave type) may be used. The display unit 45 and the position sensor 46 are electrically connected with the gaming control unit 100 (cf. FIG. 2) via a common cable 42B and a connector 41B mounted on the base 41. The connection allows the display unit 45 to receive commands and image data from the game control unit 100, and the position sensor 46 to send signals indicating detected positions.

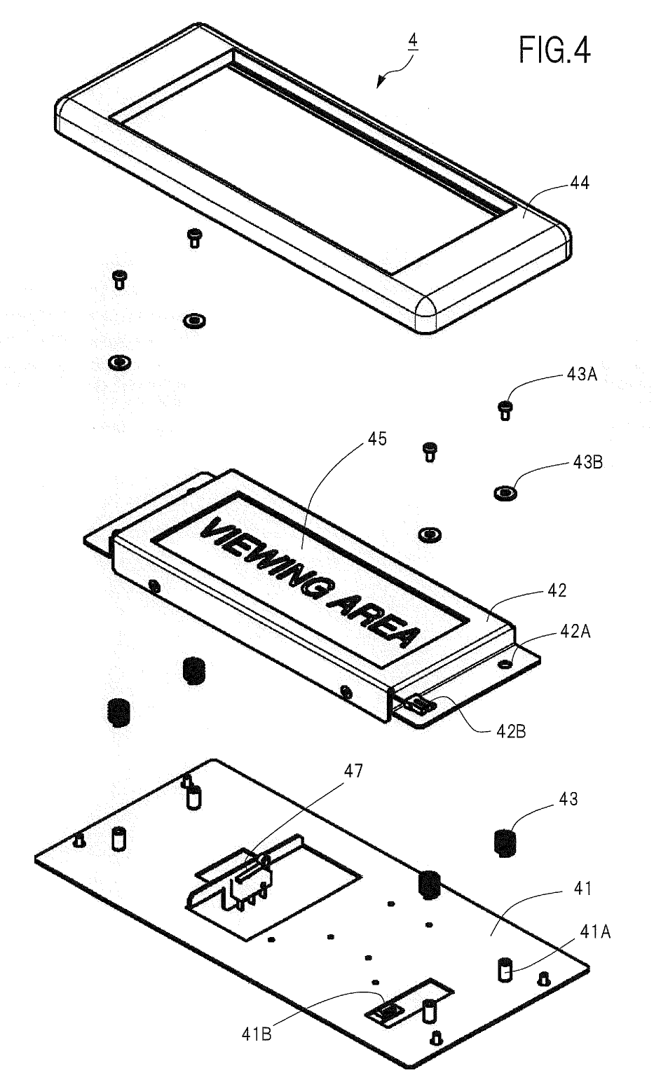

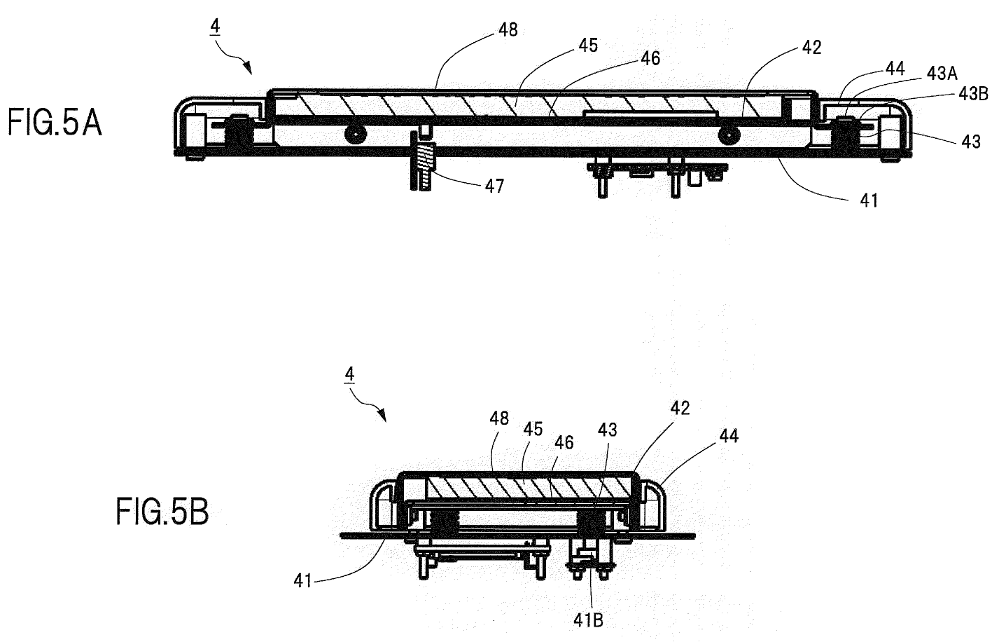

The mechanical switch unit 47 is preferably mounted between the base 41 and the moving unit 42, and configured to be turned on and off depending on the position of the moving unit 42 in the direction perpendicular to the surface of the base 41. As shown in FIGS. 4 and 5A, the mechanical switch unit 47 is more preferably fixed on the center portion of the base 41 opposed to the center portion of the bottom surface of the moving unit 42. This mechanical switch unit 47 is separated from the bottom surface of the moving unit 42 and maintained at the off position until a player pushes the top surface of the moving unit 42. When the player pushes and lowers the moving unit 42, and thereby the bottom surface of the moving unit 42 touches and pushes the mechanical switch unit 47, the mechanical switch unit 47 is turned on. The mechanical switch unit 47 is electrically connected with the gaming control unit 100 (cf. FIG. 2), and sends signals when it will be turned on and off.

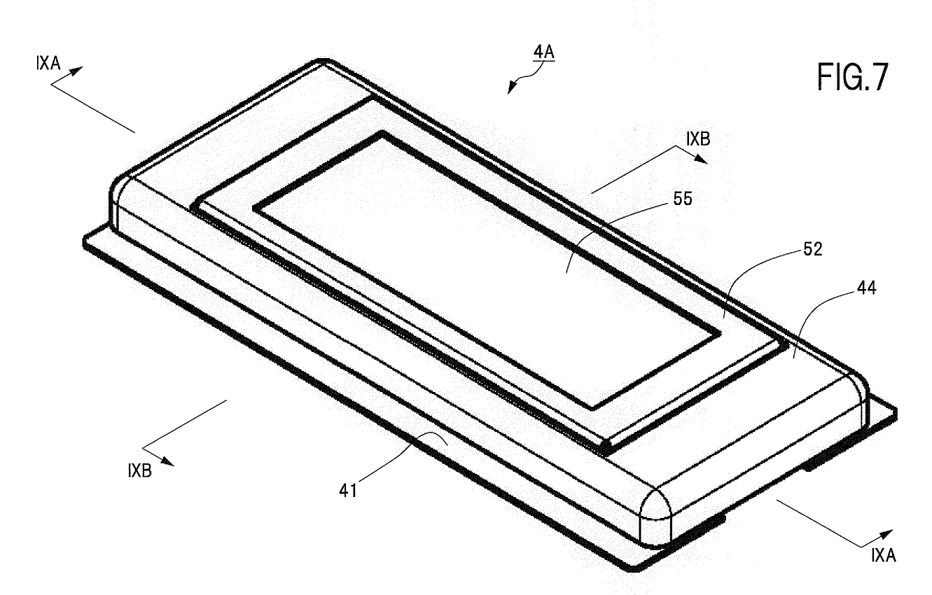

As shown in FIGS. 7, 8, 9A, and 9B, another example of the touch panel switch assembly 4A also comprises a base 41, a moving unit 52, elastic members 43, a frame 44, a display unit 55, a position sensor 46, and a pair of mechanical switch units 57. The components of this touch panel switch assembly 4A are similar to the components of the above-described touch panel switch assembly 4, except that the display unit 55 is separated from the moving unit 52 and mounted on the base 41, and the pair of the mechanical switch units 57 are placed at the ends of the base 41. A description of the similar components can be found above in the description of the touch panel switch assembly 4.

The corners of the moving unit 52 are supported by the base 41 through the elastic members 43 coupled to spacers 41A on the base 41. The moving unit 52 is thereby configured to move in the direction perpendicular to the surface of the base 41. The movable range of the moving unit 52 is adjusted by the length of the spacers 41A. In particular, the bottom surface of the lowered moving unit 52 does not touch the screen of the display unit 55.

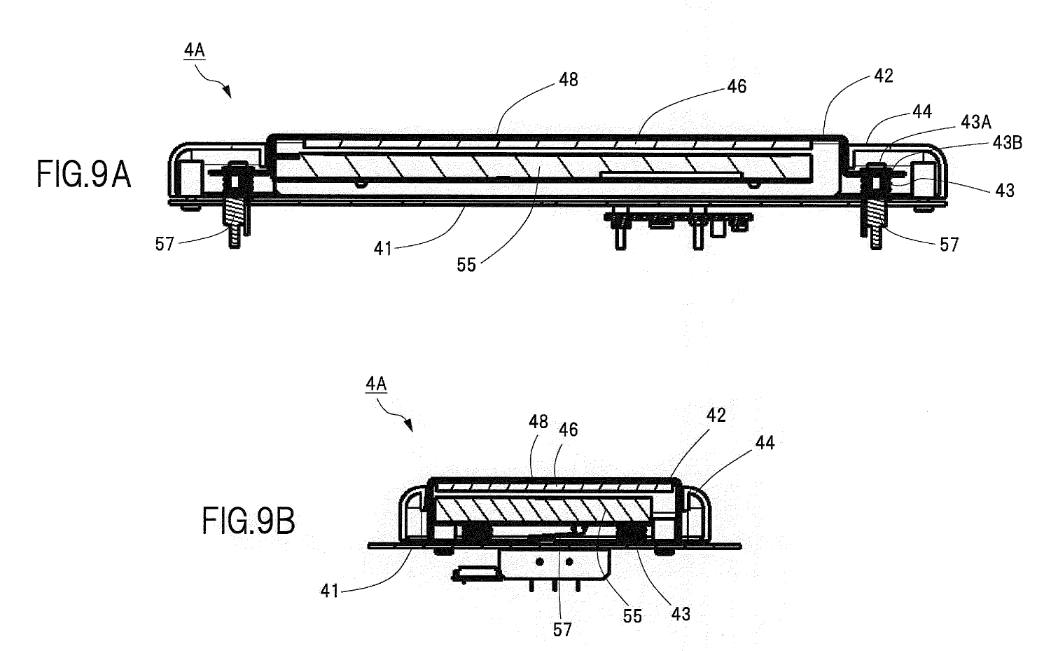

In contrast to the moving unit 42 shown in FIGS. 3-5B, the moving unit 52 comprises only the position sensor 46 covered with the cover sheet 48 as shown in FIGS. 9A and 9B. In this case, the position sensor 46 has to be optically transparent, or alternatively, an infrared type may be used as the position sensor 46.

The display unit 55 is preferably of a panel type such as LCD implemented on a glass substrate and a matrix of LEDs. Alternatively, the display unit 45 may be of a film type such as flexible LCD, OLED, and electric paper. Furthermore, a portion of a larger display device mounted directly on the cabinet 1 (cf. FIG. 1) may be used instead of the display unit 55. The display unit 55 is electrically connected with the gaming control unit 100 (cf. FIG. 2) via a cable 55A and a connector 41B mounted on the base 41. The connection allows the display unit 55 to receive commands and image data from the game control unit 100.

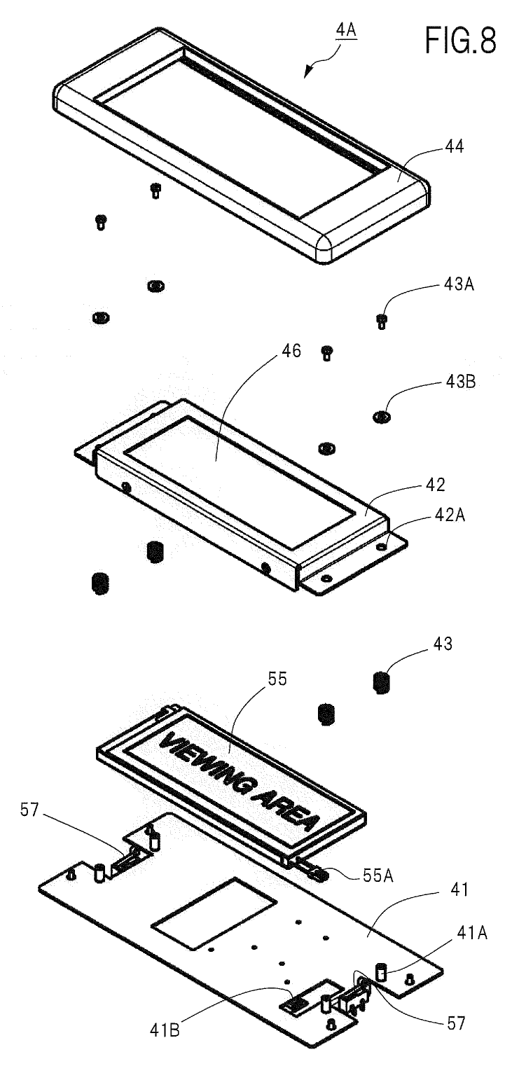

As shown in FIGS. 8 and 9A, the pair of the mechanical switch units 57 is preferably fixed on the longitudinal ends of the base 41 opposed to the longitudinal ends of the bottom surface of the moving unit 52. Each mechanical switch unit 57 is separated from the bottom surface of the moving unit 52 and maintained at the off position until a player pushes the top surface of the moving unit 52. When the player pushes and lowers the moving unit 52, and thereby the bottom surface of the moving unit 52 touches and pushes the mechanical switch units 57, the mechanical switch units 57 are turned on. The mechanical switch units 57 are electrically connected with the gaming control unit 100 (cf. FIG. 2), and send signals when they will be turned on and off. Even if the restoring forces of the elastic members 43 are thrown off balance, and the moving unit 52 is excessively tilted, either of the mechanical switch units 57 can be reliably turned on.

A player enters coins and bills into the coin and bill slots 5A and 5B, respectively. The coin counter 103 (cf. FIG. 2) counts the coins and bills. The coin acceptor 104 validates the coins and bills. The total amount of the validated coins and bills are displayed, for example, on the main display device 3B as credits available to the player. The coin hopper 105 holds a large number of coins, and discharges the coins equivalent to the credits that the player has won on a game from the coin chute 6A into the coin tray 6B. Note that the bill slot 5B may support the ticket-in/ticket-out system, i.e., accept and print a bar-coded paper ticket. The speaker 7 is installed inside the cabinet 1, and generates voice announcements and sound effects under control of the game control unit 100.

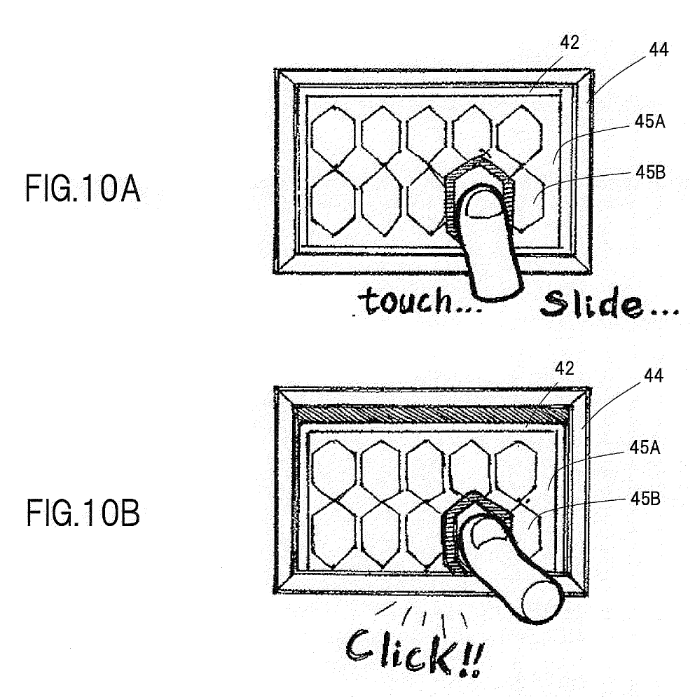

The game control unit 100 is preferably comprised of a microcomputer including a CPU, a ROM, and a RAM. The game control unit 100 stores one or more types of game programs. When receiving a cue for the start of a game from a player through the touch panel switch assembly 4, or when detecting that a player enters coins/bills into the coin/bill slots 5A/5B, the game control unit 100 preferably allows the player to select a desired one of the game programs by using the touch panel switch assembly 4 as follows. The game control unit 100 first displays a message for urging selection of a game program on the main display device 3B, and a matrix of virtual buttons 45B on the screen 45A of the display unit 45 as shown in FIG. 10A. Each of the virtual buttons 45B is assigned to one of the game programs. Then, the game control unit 100 monitors the relationship between the virtual buttons 45B and the detected position by the position sensor 46, and quickly changes the simplified or full game screen of a game program on the main display device 3B each time the player touches the virtual button 45B assigned to the game program. When the player further pushes the moving unit 42 as shown in FIG. 10B, and thereby turns on the mechanical switch unit 47, the game control unit 100 identifies and invokes the selected game program assigned to the virtual button 45B that the player touches. Here, the sufficiently tactile feedback from the moving unit 42 can help the player confirm that he/she correctly touches the virtual button 45B assigned to the gaming program to be selected.

After that, the game control unit 100 conducts the game according to the executed game program, and in particular, controls the above-described components installed on the gaming machine 10, depending on the game status as follows.

The game control unit 100 first detects and accepts the coins/bills that the player has entered into the coin/bill slots 5A and 5B, and then increases the credits of the player by the count provided by the coin counter 103. In parallel with that, the game control unit 100 starts to produce visual and sound effects by using the lamp 2, the display devices 3A, 3B, the display unit 45, and the speaker 7.

The game control unit 100 next displays video reels on the main display device 3B, and a matrix of virtual buttons 45B on the screen 45A of the display unit 45 as shown in FIG. 10A. Preferably, each virtual button 45B aligned in the first row is assigned to an available payline, and each virtual button 45B aligned in the second row is assigned to an amount of a bet. Then, the game control unit 100 monitors the relationship between the virtual buttons 45B and the detected position by the position sensor 46, and quickly changes the selected payline and amount of the bet on the display devices 3A and/or 3B each time the player touches the virtual button 45B assigned to the payline or the amount of the bet. When the player further pushes the moving unit 42 as shown in FIG. 10B, and thereby turns on the mechanical switch unit 47, the game control unit 100 identifies the selected payline and the amount of the bet assigned to the virtual buttons 45B that the player last touches. Here, the sufficiently tactile feedback from the moving unit 42 can help the player confirm that he/she correctly touches the virtual buttons 45B assigned to the payline and the amount of the bet to be selected. The game control unit 100 then decreases the credits by the amount of the bet, and displays the amounts of the bet and the available credits, and the selected paylines on the display devices 3A and 3B.

The game control unit 100 preferably spins the video reels at the same time when the mechanical switch unit 47 turns on. On the other hand, the game control unit 100 randomly determines symbols to be displayed on the video reels when it will stop them. Furthermore, the game control unit 100 checks a winning combination of symbols in the symbols to be arranged on the stopped video reels, and thereby determines whether or not to provide an award to the player. After a predetermined time has elapsed from the start of the spin, the game control unit 100 stops the video reels at the predetermined positions. If a winning combination that represents an amount of a payout is detected, the game control unit 100 will increase the credits of the player by the payout, or causes the coin hopper 105 to discharge the coins equivalent to the payouts. In addition, the game control unit 100 controls the lamp 2, the display devices 3A, 3B, the display unit 45, and the speaker 7 to produce visual and sound effects to announce the winning of the payout.

### General Interpretation of Terms

In understanding the scope of the present invention, the term “configured” as used herein to describe a component, section or part of a device includes hardware and/or software that is constructed and/or programmed to carry out the desired function. In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A touch panel switch assembly comprising:
a base;
a moving unit supported by the base and configured to move in a direction perpendicular to the surface of the base;
an elastic member connected between the base and the moving unit, and configured to exert a restoring force therebetween when a user has displaced the moving unit in the direction perpendicular to the surface of the base;
a display unit mounted on the base or the moving unit, and configured to be visible through the surface of the moving unit;
a position sensor mounted on the moving unit, and configured to detect a position on the surface of the moving unit where the user has touched; and
a mechanical switch unit mounted between the base and the moving unit, and configured to be turned on and off depending on the position of the moving unit in the direction perpendicular to the surface of the base.

2. A touch panel switch assembly according to claim 1, wherein the display unit is of a panel or film type, and is configured to form or be mounted on the surface of the moving unit.

3. A touch panel switch assembly according to claim 1, wherein the position sensor is configured to be a resistive or capacitive touch panel, and covered with or overlaid on the screen of the display unit.

4. A gaming machine comprising:
a cabinet;
a touch panel switch assembly comprising:
a base fixed on the cabinet;
a moving unit supported by the base and configured to move in a direction perpendicular to the surface of the base;
an elastic member connected between the base and the moving unit, and configured to exert a restoring force therebetween when a player has displaced the moving unit in the direction perpendicular to the surface of the base;
a display unit mounted on the base or the moving unit, and configured to be visible through the surface of the moving unit;
a position sensor mounted on the moving unit, and configured to detect a position on the surface of the moving unit where the player has touched; and
a mechanical switch unit mounted between the base and the moving unit, and configured to be turned on and off depending on the position of the moving unit in the direction perpendicular to the surface of the base; and
a game control unit configured to execute a game program, and thereby
control images on the display unit,
identify the data that the player has entered into the gaming machine by using the relationship between the images displayed on the display unit and the positions detected by the position sensor, and the on and off positions of the mechanical switch unit,
control game functions depending on the identified data, and
provide the player with an award depending on the game result and the identified data.

5. A gaming machine according to claim 4, wherein the game control unit is configured to:
assign available data options to specific images;
display a matrix of the specific images on the display unit; and
identify the data option assigned to the specific image displayed at the position that has been detected by the position sensor.

6. A gaming machine according to claim 4, wherein the game control unit is configured to perform a game function according to the identified data when detecting that the player has pushed the moving unit and thereby turned on the mechanical switch unit.
